(19) United States
(12) Patent Application Publication
(10) Pub. No.: US 2010/0204045 A1
(43) Pub. Date: Aug. 12, 2010

(54) Systemicity Enhancers

(75) Inventors: Yvonne Dieckmann, Hassloch (DE); Michael Ishaque, Mannheim (DE); Ingo Muenster, Boehl-Iggelheim (DE); Laurent Picard, Bad Bergzabern (DE); Angelika Benz, Roemerberg (DE); Juergen Langewald, Mannheim (DE); Klaus Kreuz, Denzlingen (DE); Harald Koehle, Bobenheim (DE); Felix Christian Goerth, Sewickley, PA (US); Roman Benedikt Raether, Speyer (DE); Jurith Montag, Limburgerhof (DE); Ursula Huber-Moulliet, Frankenthal (DE); Wolfgang Kerl, Mannheim (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/679,765

(22) PCT Filed: Sep. 10, 2008
(86) PCT No.: PCT/EP08/61959

§ 371 Date: Mar. 24, 2010

(30) Foreign Application Priority Data
Sep. 27, 2007 (EP) 07117372.8

(51) Int. Cl. A01N 25/26; A01N 25/00; A01N 43/56; A01N 33/26; A01P 3/00; A01P 7/04

(52) U.S. Cl. 504/100; 514/772.4; 514/406; 514/639; 514/407

(57) ABSTRACT

A copolymer obtainable by polymerization of
a) at least one compound of the formula (I) (monomer α)
   where

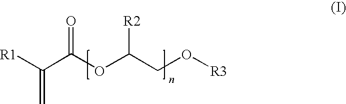

R1 and R2, independently of one another, are in each case H or CH₃,
R3 is C₆-C₁₀-aryl or C₇-C₁₂-aralkyl which can carry one or more identical or different C₁-C₉-alkyl and/or C₁-C₅-alkoxy substituents, and
n is an integer from 0 to 100,
b) at least one compound chosen from the group of N-vinylamides, N-vinyllactams, N-vinylimines and N-vinylamines with 2 to 15 carbon atoms (monomer β),
c) if appropriate one or more different difunctional crosslinker components and
d) if appropriate one or more different regulators and
e) if appropriate one or more further copolymerizable components (monomer γ)
   is useful for increasing the systemicity of a pesticide.

The invention relates to the use of copolymers obtainable by polymerization of mono-ethylenically unsaturated carboxylic esters with N-vinylamides, N-vinyllactams, N-vinylamines or N-vinylimines in crop protection formulations, and specific crop protection formulations comprising those copolymers.

Systemic pesticides are compounds that are taken up by plants, e.g. through the roots or leaves, and that are translocated in the plant in the phloem, the transport system that carries nutrients to all parts of the plant where they are needed.

Systemic pesticides provide the farmer lots of benefits: The uptake of pesticide of plants, which can be achieved either by seed treatment, foliar treatment or soil treatment, which is the simultaneous or sequential application of seeds and respective formulation (e.g. granule formulations), leads to plants, which are much longer resistant towards pests than plants treated with non-systemic pesticides.

Also for pesticides which provide plant health effects it is desirable to increase their uptake in the plant. The term “plant health” describes for example, advantageous properties such as improved crop characteristics including, but not limited to better emergence, increased crop yields, more favourable protein and/or content, more favourable aminoacid and/or oil composition, more developed root system (improved root growth), tillering increase, increase in plant height, bigger leaf blade, less dead basal leaves, stronger tillers, greener leaf colour, pigment content, photosynthetic activity, less fertilizers needed, less seeds needed, more productive tillers, earlier flowering, early grain maturity, less plant verse (lodging), increased shoot growth, enhanced plant vigor, increased plant stand or early germination; or a combination of at least two or more of the aforementioned effects or any other advantages familiar to a person skilled in the art.

Many pesticides, however, do not show satisfactory systemicity. Furthermore, the systemicity of known systemic pesticides leaves room for improvement.

It is therefore an object of the invention to improve the systemicity of pesticides, preferably of pesticides with low or no systemicity.

Various polymers that are useful as solubilizers are known in the art.

“Solubilizing” means that a pesticide that is sparingly soluble or insoluble in water is stably and uniformly distributed in an aqueous phase with the help of an auxiliary compound, which may be an amphiphilic block-copolymer.

However, the fact a pesticide is evenly distributed in an aqueous phase does not necessarily mean that it is also well taken up by the roots or leaves of a plant and that it will be easily transported in the phloem.

EP-A 0 506 313 discloses that the systemic activity of systemic pesticides is increased when a water soluble polymer is included in the agrochemical formulation.

It has now been found that copolymers obtainable by polymerization of monoethylenically unsaturated carboxylic esters with N-vinylamides, N-vinyllactams, N-vinylamines or N-vinylimines are particularly useful for enhancing the systemicity of pesticides.

Such copolymers are known from WO 2006/018135 as solubilizers and a use in crop protection preparations is suggested in this document. However, a systemicity enhancing effect of the copolymers is not mentioned. K. A. Basha et al. describe the synthesis of copolymers of phenoxyethyl methacrylate with N-vinyl-2-pyrrolidone. An activity as a systemicity enhancer is not disclosed.

Accordingly, in one aspect of the invention there is provided the use of a copolymer obtainable by polymerization of
a) at least one compound of the formula (I) (monomer α)
   where

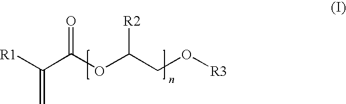

R1 and R2, independently of one another, are in each case H or CH₃,
R3 is C₆-C₁₀-aryl or C₇-C₁₂-aralkyl which can carry one or more identical or different C₁-C₉-alkyl and/or C₁-C₅-alkoxy substituents, and
n is an integer from 0 to 100,
b) at least one compound chosen from the group of N-vinylamides, N-vinyllactams, N-vinylimines and N-vinylamines with 2 to 15 carbon atoms (monomer β),
c) if appropriate one or more different difunctional crosslinker components and
d) if appropriate one or more different regulators and
e) if appropriate one or more further copolymerizable components (monomer γ)
   for increasing the systemicity of a pesticide.

The use according to the invention leads to an increased uptake of desired pesticides by plants and thus to increased fungi, pest and weed control, as well as to an increased plant health effect.

In a further aspect of the invention there is provided a method for increasing the systemicity of a pesticide, which comprises the step of applying the pesticide in combination with a copolymer of the invention to a plant or its seed or other propagation material.

According to the invention “to increase the systemicity” means that the uptake of a given pesticide within 7 days of treatment is increased by at least 15% preferably 25-%, more preferred 33-%, as compared to a treatment with a formulation that is identical except for the absence of the specific copolymer(s).

Preferably, the pesticide is already systemic to a certain extent. More preferred, the pesticide has a log P value of ≦5-4 (determined according to EEC directive 79/831 Annex V. A8 by HPCC, gradient method, acetonitrile/0.1% aqueous phosphoric acid), in particular a log P value of ≦5 4 and ≧0.1.

When use is made of the copolymers' utility as systemicity enhancers, the application of the copolymers of the invention typically differs from cases where the utility as solubilizers is employed. E.g., the ratio of active ingredient to copolymer is typically lower in cases where systemicity is increased, and is preferably <6. Further, to increase systemicity, copolymers of the invention can be added to aqueous formulations of water soluble active ingredients which do not need any solubilizers. Likewise, the copolymers of the invention can be added to formulations already containing different solubilizers, where solubility is not further increased but the systemicity of the active ingredient is improved.

The copolymers to be used according to the invention are obtainable by polymerization of at least one copolymerizable monomer of the formula (I) (monomer α)

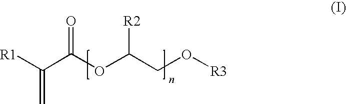

with at least one further copolymerizable monomer chosen from the group consisting of the N-vinylamides, N-vinyllactams, N-vinylimines and N-vinylamines with 2 to 15 carbon atoms (monomer β).

Here, in formula (I), the radicals R1 and R2 can, in each case independently of one another, assume the meanings H and/or methyl. These are thus derivatives of acrylic acid and/or of methacrylic acid. The radical R3 means a C₆-C₁₀-aryl radical, such as, for example, phenyl or naphthyl, or a C₇-C₁₂-aralkyl radical, such as, for example, benzyl, phenylethyl or phenylpropyl.

The radicals specified for R3 can carry one or more, generally 1 to 3, identical or different C₁-C₉-alkyl and/or C₁-C₅-alkoxy substituents which may be straight-chain or branched, or open-chain, cyclic or alicyclic. Examples of C₁-C₉-alkyl substituents which may be specified are: methyl, ethyl, 1-propyl, 2-propyl, 1-butyl, 2-butyl, 1,1-dimethylethyl, 1-pentyl, 2-pentyl, 1-hexyl, cyclohexyl, 1-heptyl, 1-octyl, 1-nonyl. Examples of C₁-C₅-alkoxy substituents which may be mentioned are: methoxy, ethoxy, propoxy, 2-propoxy, 1-butoxy, 2-butoxy, 1,1-dimethylethoxy, 1-pentoxy, 2,2-dimethylpropoxy. Preferred radicals R3 are, for example: phenyl, para-tolyl, benzyl, para-hydroxybenzyl, para-hydroxyphenyl, para-methoxyphenyl, para-methoxybenzyl or cyclohexyl.

The index n in formula (I) is an integer from 0 to 100, preferably from 1 to 100, particularly preferably from 1 to 25 and in particular from 1 to 10. If n is a number greater than 1, then the radicals R2 of the individual repeat units may in each have the same meaning or, independently of one another, if appropriate in random distribution, are in each case H or CH₃. In this case, preferably about 50% to about 100% of the radicals R2 are H and about 0 to about 50% of the radicals R2 are CH₃. In a preferred embodiment of the process according to the invention, in the case where n is a number greater than 1, all of the radicals assume the same meaning. R2 is then particularly preferably H.

The specified copolymerizable monomers of the formula (I) are obtainable by the methods for the synthesis of esters that are known per se to the person skilled in the art, as described, for example, in Vollhardt, Peter; Organische Chemie [Organic Chemistry], pages 768-774, 1988, VCH, New York or else in EP-A 646567.

Copolymers which can be used according to the invention are obtained by polymerizing monomer mixtures which generally comprise about 0.1 to 99.9 mol %, based on the total weight of the monomers used, of the at least one monomer α. Preferably, these monomer mixtures comprise about 1 to about 50 mol %, particularly preferably about 1 to about 30 mol %, of the at least one monomer α. The monomer α can be used in pure form or in the form of mixtures of two or more different compounds as defined by formula (I).

Moreover, to prepare the copolymer to be used according to the invention, at least one further copolymerizable monomer (monomer β) is used which is chosen from the groups N-vinylamides, N-vinyllactams, N-vinylimines and/or N-vinylamines, preferably N-vinylamides and N-vinyllactames. The monomers chosen usually have 2 to 15 carbon atoms, preferably 2 to 10 carbon atoms. Examples of the N-vinylamides and N-vinyllactams which may be mentioned are those which are characterized by the following formula (II):

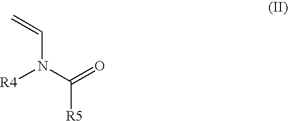

in which
R4, R5 independently of one another, are H or C₁-C₆-alkyl or together can form a 4- to 8-membered cycle which may be saturated or mono- or polyunsaturated and can if appropriate carry further substituents.

Suitable open-chain compounds of this type are, for example, N-vinylformamide, N-vinyl-N-methylformamide, N-vinyl-N-ethylformamide, N-vinyl-N-propylformamide, N-vinyl-N-isopropylformamide, N-vinyl-N-n-butylformamide, N-vinyl-N-isobutylformamide, N-vinyl-N-t-butylformamide, N-vinyl-N-n-pentylformamide, N-vinyl-N-n-hexylformamide, N-vinylacetamide, N-vinyl-N-methylacetamide, N-vinyl-N-ethylacetamide, N-vinylpropionamide, N-vinyl-N-methylpropionamide and N-vinylbutyramide. Particular preference is given to N-vinylformamide and N-vinyl-N-methylacetamide.

Of the cyclic N-vinylamides, the N-vinyllactams, examples which may be mentioned are N-vinylpyrrolidone, N-vinylpiperidone and N-vinylcaprolactam. According to the invention, preference is given to the N-vinylpyrrolidone while of the open-chain N-vinylamides preference is given to using N-vinylformamide. Copolymers of, for example, N-vinylformamide and N-vinylpyrrolidone which may be present in the copolymer in a desired ratio can also be used in the manner according to the invention.

Alternatively to this, it is also possible to use N-vinylamines, in particular N-vinylamine, and N-vinylimines, such as, for example, N-vinylimidazole, N-vinyl-2-methylimidazole, N-vinyl-4-methylimidazole, preferably N-vinylimidazole, as monomers for preparing the copolymers to be used according to the invention.

Copolymers which can be used according to the invention are obtained by polymerization of monomer mixtures which generally comprise about 0.1 to 99.9 mol %, based on the total weight of the monomers used, of the at least one monomer β. Preferably, these monomer mixtures comprise about 50 to about 99 mol %, more preferred about 70 to about 99 mol %, of the at least one monomer β, in particular 90 to 99 mol % of the at least one monomer β and 1 to 10 mol % monomer α. The monomers β can be used in pure form or in the form of mixtures of two or more different of the abovementioned compounds.

The copolymers to be used according to the invention are obtained by copolymerization of at least one monomer of the formula (I) (monomer α) with at least one further monomer chosen from the groups of N-vinylamides and N-vinyllactams, N-vinylimines and/or N-vinylamines (monomer β). The polymerization can in principle be carried out by all methods which appear to be suitable to the person skilled in the art. A free-radical polymerization is particularly advantageously carried out under the conditions customary for this type of polymerization and/or in the presence of the reagents suitable for this, such as, for example, free-radical initiators.

The copolymers have K values of at least 7, preferably from 20 to 50, particularly preferably from 25 to 45. The K values are determined in accordance with H. Fikentscher, Cellulose-Chemie, Volume 13, 58 to 64 and 71 to 74 (1932) in aqueous solution at 25° C., at concentrations between 0.1% and 5% depending on the K value range.

The preparation is carried out by known processes, e.g. solution, precipitation or inverse suspension polymerization using compounds which form free radicals under the polymerization conditions. The polymerization temperatures are usually in the range from 30 to 200° C., preferably 40 to 110° C. Suitable initiators (free-radical initiators) are, for example, azo and peroxy compounds, and the customary redox initiator systems, such as combinations of hydrogen peroxide and reducing compounds, e.g. sodium sulfite, sodium bisulfite, sodium formaldehyde sulfoxylate and hydrazine.

The reaction media used are the customary solvents in which the monomers are soluble. Preference is given to using alcoholic solvents, such as, for example, methanol, ethanol, n-propanol or isopropanol in pure form or in the form of their mixtures. Said solvents can also be used in the form of mixtures with water.

In order to ensure that the reactions lead to homogeneous products, it is advantageous to introduce the monomers and the initiator into the reaction solution separately. This can be carried out, for example, in the form of separate feeds for the individual reactants.

The solids content of the resulting organic solution is usually 20 to 60% by weight, in particular 25 to 40% by weight.

The solvent used for the polymerization can then be removed by means of steam distillation and be replaced with water.

The solutions of the copolymers can be converted into powder form by various drying processes, such as, for example, spray drying, fluidized spray drying, drum drying or freeze drying, and an aqueous dispersion and solution can be prepared again from the powder form by redispersion in water.

The preparation of the copolymers which can be used according to the invention can also be carried out in presence of suitable difunctional crosslinker components (crosslinkers) and/or in the presence of suitable regulators.

Suitable crosslinkers are those monomers which have a crosslinking function, for example compounds with at least two ethylenically unsaturated, nonconjugated double bonds in the molecule.

Examples therefor are acrylic esters, methacrylic esters, allyl ethers or vinyl ethers of at least dihydric alcohols. The OH groups of the parent alcohols can here be completely or partially etherified or esterified; however, the crosslinkers comprise at least two ethylenically unsaturated groups.

Examples of the parent alcohols are dihydric alcohols such as 1,2-ethanediol, 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentyl glycol, 3-methylpentane-1,5-diol, 2,5-dimethyl-1,3-hexanediol, 2,2,4-trimethyl-1,3-pentanediol, 1,2-cyclohexanediol, 1,4-cyclohexanediol, 1,4-bis(hydroxymethyl)cyclohexane, hydroxypivalic neopentyl glycol monoester, 2,2-bis(4-hydroxyphenyl)propane, 2,2-bis[4-(2-hydroxypropyl)phenyl]propane, diethylene glycol, triethylene glycol, tetraethylene glycol, dipropylene glycol, tripropylene glycol, tetrapropylene glycol, 3-thiopentane-1,5-diol, and polyethylene glycols, polypropylene glycols and polytetrahydrofurans with molecular weights of in each case 200 to 10 000. Apart from the homopolymers of ethylene oxide and propylene oxide, it is also possible to use block copolymers of ethylene oxide or propylene oxide or copolymers which comprise ethylene oxide and propylene oxide groups in incorporated form. Examples of parent alcohols with more than two OH groups are trimethylolpropane, glycerol, pentaerythritol, 1,2,5-pentanetriol, 1,2,6-hexanetriol, triethoxycyanuric acid, sorbitan, sugars such as sucrose, glucose, mannose. It is of course also possible to use the polyhydric alcohols following reaction with ethylene oxide and propylene oxide as the corresponding ethoxylates or propoxylates, respectively. The polyhydric alcohols can also firstly be converted to the corresponding glycidyl ethers by reaction with epichlorohydrin.

Further suitable crosslinkers are the vinyl esters or the esters of monohydric unsaturated alcohols with ethylenically unsaturated C₃-C₆-carboxylic acids, for example acrylic acid, methacrylic acid, itaconic acid, maleic acid or fumaric acid. Examples of such alcohols are allyl alcohol, 1-buten-3-ol, 5-hexen-1-ol, 1-octen-3-ol, 9-decen-1-ol, dicyclopentenyl alcohol, 10-undecen-1-ol, cinnamyl alcohol, citronellol, crotyl alcohol or cis-9-octadecen-1-ol. It is, however, also possible to esterify the monohydric, unsaturated alcohols with polybasic carboxylic acids, for example malonic acid, tartaric acid, trimellitic acid, phthalic acid, terephthalic acid, citric acid or succinic acid.

Further suitable crosslinkers are esters of unsaturated carboxylic acids with the above-described polyhydric alcohols, for example oleic acid, crotonic acid, cinnamic acid or 10-undecenoic acid.

Suitable crosslinkers are also straight-chain or branched, linear or cyclic, aliphatic or aromatic hydrocarbons which have at least two double bonds which, in the case of aliphatic hydrocarbons, must not be conjugated, e.g. divinylbenzene, divinyltoluene, 1,7-octadiene, 1,9-decadiene, 4-vinyl-1-cyclohexene, trivinylcyclohexane or polybutadienes with molecular weights of from 200 to 20 000.

Suitable crosslinkers are also the acrylamides, methacrylamides and N-allylamines of at least difunctional amines. Such amines are, for example, 1,2-diaminomethane, 1,2-diaminoethane, 1,3-diaminopropane, 1,4-diaminobutane, 1,6-diaminohexane, 1,12-dodecandiamine, piperazine, diethylenetriamine or isophoronediamine. Likewise suitable are the amides of allylamine and unsaturated carboxylic acids, such as acrylic acid, methacrylic acid, itaconic acid, maleic acid, or at least dibasic carboxylic acids as have been described above.

Also suitable as crosslinkers are triallylamine and triallylmonoalkylammonium salts, e.g. triallylmethylammonium chloride or methylsulfate.

Also suitable are N-vinyl compounds of urea derivatives, at least difunctional amides, cyanurates or urethanes, for example of urea, ethyleneurea, propyleneurea or tartardiamide, e.g. N,N′-divinylethyleneurea or N,N′-divinylpropyleneurea.

Further suitable crosslinkers are divinyldioxane, tetraallylsilane or tetravinylsilane.

It is of course also possible to use mixtures of the abovementioned compounds. Preference is given to using those crosslinkers which are soluble in the monomer mixture.

Particularly preferably used crosslinkers are, for example, methylenebisacrylamide, triallylamine and triallylalkylammonium salts, divinylimidazole, pentaerythritol triallyl ether, N,N′-divinylethyleneurea, reaction products of polyhydric alcohols with acrylic acid or methacrylic acid, methacrylic esters and acrylic esters of polyalkylene oxides or polyhydric alcohols which have been reacted with ethylene oxide and/or propylene oxide and/or epichlorohydrin.

Very particularly preferred crosslinkers are pentaerythritol Wallyl ether, methylenebisacrylamide, N,N′-divinylethyleneurea, triallylamine and triallylmonoalkylammonium salts, and acrylic esters of glycol, butanediol, trimethylolpropane or glycerol or acrylic esters of glycol, butanediol, trimethylolpropane or glycerol reacted with ethylene oxide and/or epichlorohydrin.

The difunctional crosslinker component can be used for the preparation of the copolymers to be used according to the invention in amounts of from 0 to about 5 mol %, preferably from 0 to about 3 mol %, based on the total amount of the monomers used, either in pure form or in the form of a mixture of two or more crosslinkers.

The preparation of the copolymers which can be used according to the invention can also be carried out in the presence of suitable regulators. Regulators (polymerization regulators) is the term generally used to refer to compounds with high transfer constants. Regulators accelerate chain-transfer reactions and thus bring about a reduction in the degree of polymerization of the resulting polymers without influencing the gross reaction rate.

With the regulators, a distinction can be made between mono-, bi- or polyfunctional regulators, depending on the number of functional groups in the molecule which may lead to one or more chain transfer reactions. Suitable regulators are described, for example, in detail by K. C. Berger and G. Brandrup in J. Brandrup, E. H. Immergut, Polymer Handbook, 3rd Edition, John Wiley & Sons, New York, 1989, pp. II/81-II/141.

Suitable regulators are, for example, aldehydes such as formaldehyde, acetaldehyde, propionaldehyde, n-butyraldehyde, isobutyraldehyde.

Further regulators which may also be used are: formic acid, its salts or esters, such as ammonium formate, 2,5-diphenyl-1-hexene, hydroxylammonium sulfate, and hydroxylammonium phosphate.

Further suitable regulators are halogen compounds, e.g. alkyl halides, such as tetrachloromethane, chloroform, bromotrichloromethane, bromoform, allyl bromide, and benzyl compounds, such as benzyl chloride or benzyl bromide.

Further suitable regulators are allyl compounds, such as, for example, allyl alcohol, functionalized allyl ethers, such as allyl ethoxylates, alkyl allyl ethers, or glycerol monoallyl ether.

The regulators preferably used are compounds which comprise sulfur in bonded form.

Compounds of this type are, for example, inorganic hydrogensulfites, disulfites and dithionites or organic sulfides, disulfides, polysulfides, sulfoxides and sulfones. These include di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide.

Particular preference is given to organic compounds which comprise sulfur in bonded form.

Compounds preferably used as polymerization regulators are thiols (compounds which comprise sulfur in the form of SH groups, also referred to as mercaptans). Preferred regulators are mono-, bi- and polyfunctional mercaptans, mercaptoalcohols and/or mercaptocarboxylic acids.

Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans, such as n-butyl mercaptan, n-hexyl mercaptan or n-dodecyl mercaptan.

Particularly preferred thiols are cysteine, 2-mercaptoethanol, 1,3-mercaptopropanol, 3-mercaptopropane-1,2-diol, thioglycerol, thiourea.

Examples of bifunctional regulators which comprise two sulfurs in bonded form are bifunctional thiols, such as, for example, dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bis-thioglycolate.

Examples of polyfunctional regulators are compounds which comprise more than two sulfurs in bonded form. Examples thereof are trifunctional and/or tetrafunctional mercaptans.

Preferred trifunctional regulators are trifunctional mercaptans, such as, for example, trimethylolpropane tris(2-mercaptoethanate), trimethylolpropane tris(3-mercaptopropionate), trimethylolpropane tris(4-mercaptobutanate), trimethylolpropane tris(5-mercaptopentanate), trimethylolpropane tris(6-mercaptohexanate), trimethylolpropane tris(2-mercaptoacetate), glyceryl thioglycolate, glyceryl thiopropionate, glyceryl thioethoxide, glyceryl thiobutanoate, 1,1,1-propanetriyl tris(mercaptoacetate), 1,1,1-propanetriyl tris(mercaptoethanoate), 1,1,1-propanetriyl tris(mercaptopropionate), 1,1,1-propanetriyl tris(mercaptobutanoate), 2-hydroxmethyl-2-methyl-1,3-propanediol tris(mercaptoacetate), 2-hydroxmethyl-2-methyl-1,3-propanediol tris(mercaptoethanoate), 2-hydroxmethyl-2-methyl-1,3-propanediol tris(mercaptopropionate), 2-hydroxmethyl-2-methyl-1,3-propanediol tris(mercaptobutanoate).

Particularly preferred trifunctional regulators are glyceryl thioglycolate, trimethyloipropane tris(2-mercaptoacetate), 2-hydroxmethyl-2-methyl-1,3-propanediol tris(mercaptoacetate).

Preferred tetrafunctional mercaptans are pentaerythritol tetrakis(2-mercaptoacetate), pentaerythritol tetrakis(2-mercaptoethanoate), pentaerythritol tetrakis(3-mercaptopropionate), pentaerythritol tetrakis(4-mercaptobutanoate), pentaerythritol tetrakis(5-mercaptopentanoate), pentaerythritol tetrakis(6-mercaptohexanoate).

Further suitable polyfunctional regulators are Si compounds which are formed by the reaction of compounds of the formula (IIIa). Further suitable polyfunctional regulators are Si compounds of the formula (IIIb).

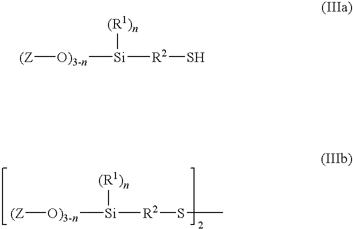

in which
n is a value from 0 to 2,
R¹ is a C₁-C₁₆-alkyl group or phenyl group,
R² is a C₁-C₁₈-alkyl group, the cyclohexyl group or phenyl group,
Z is a C₁-C₁₈-alkyl group, C₂-C₁₈-alkylene group or C₂-C₁₈-alkynyl group, whose carbon atoms may be replaced by nonadjacent oxygen or halogen atoms, or is one of the groups

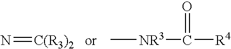

in which
R³ is a C₁-C₁₂-alkyl group and
R⁴ is a C₁-C₁₈-alkyl group.

Particular preference is given to the compounds of the formula (IIIa), of these especially mercaptopropyltrimethoxysilane and mercaptopropyltriethoxysilane.

All of the regulators specified may be used individually or in combination with one another. In a preferred embodiment of the process, multifunctional regulators are used.

During the preparation of the copolymers to be used according to the invention, the regulator can be used in amounts of from 0 to about 4 mol %, preferably from 0 to about 3 mol %, based on the total amount of the monomers used.

Moreover, during the preparation of the copolymers to be used according to the invention, one or more further copolymerizable components (monomer γ) can also be used. Examples thereof which may be mentioned are: monoethylenically unsaturated carboxylic acids having 3 to 8 carbon atoms, such as, for example, acrylic acid, methacrylic acid, dimethacrylic acid, ethacrylic acid, maleic acid, citraconic acid, methylenemalonic acid, allylacetic acid, vinylacetic acid, crotonic acid, fumaric acid, mesaconic acid and itaconic acid. In this group of monomers, preference is given to using acrylic acid, methacrylic acid, maleic acid or mixtures of the specified carboxylic acids. The monoethylenically unsaturated carboxylic acids can be used for the copolymerization in the form of the free acid and—if present—the anhydrides or in partially or completely neutralized form. In order to neutralize these monomers, preference is given to using alkali metal or alkaline earth metal bases, ammonia or amines, e.g. sodium hydroxide solution, potassium hydroxide solution, soda, potash, sodium hydrogencarbonate, magnesium oxide, calcium hydroxide, calcium oxide, gaseous or aqueous ammonia, triethylamine, ethanolamine, diethanolamine, triethanolamine, morpholine, diethylenetriamine or tetraethylenepentamine.

Further suitable monomers γ are, for example, the C₁-C₃₀-alkyl esters, amides and nitriles or the carboxylic acids given above, e.g. methyl acrylate, ethyl acrylate, methyl methacrylate, ethyl methacrylate, hydroxyethyl acrylate, hydroxypropyl acrylate, hydroxybutyl acrylate, hydroxyethyl methacrylate, hydroxypropyl methacrylate, hydroxyisobutyl acrylate, hydroxyisobutyl methacrylate, octyl acrylate, 2-ethylhexyl acrylate, 2-ethylhexyl methacrylate, nonyl acrylate, decyl acrylate, lauryl acrylate, myristyl acrylate, cetyl acrylate, stearyl acrylate, oleyl acrylate, behenyl acrylate, hexyl methacrylate, octyl methacrylate, nonyl methacrylate, decyl methacrylate, lauryl methacrylate, myristyl methacrylate, cetyl methacrylate, stearyl methacrylate, oleyl methacrylate, behenyl methacrylate or tert-butylcyclohexyl acrylate.

Moreover, suitable monomers γ are monomethyl maleate, dimethyl maleate, monoethyl maleate, diethyl maleate, acrylamide, methacrylamide, N,N-dimethylacrylamide, N-tert-butylacrylamide, acrylonitrile, methacrylonitrile, dimethylaminoethyl acrylate, diethylaminoethyl acrylate, diethylaminoethyl methacrylate and the salts of the last-mentioned monomers with carboxylic acids or mineral acids, and the quaternized products.

Furthermore suitable monomers γ are also N-alkyl- or N,N-dialkyl-substituted carboxamides of acrylic acid or of methacrylic acid, where the alkyl radicals are C₁-C₁₈-alkyl or cycloalkyl radicals, for example N-diethylacrylamide, N-isopropylacrylamide, dimethylaminopropylmethacrylamide, N-tert-octylacrylamides, N-stearylacrylamide, N-stearylmethacrylamide, N-octylacrylamide, N,N-dioctylacrylamide, N,N-dioctylmethacrylamide, N-cetylacrylamide, N-cetylmethacrylamide, N-dodecylacrylamide, N-dodecylmethacrylamide, N-myristylacrylamide or 2-ethylhexylacrylamide.

Further suitable monomers γ are also vinyl esters of aliphatic carboxylic acids (C₁- to C₃₀-carboxylic acids), for example vinyl acetate, vinyl propionate and vinyl esters of octanoic, nonanoic, decanoic, undecanoic, lauric, tridecanoic, myristic, palmitic, stearic, arachidic or behenic acid or oleic acid.

Further suitable monomers γ are, moreover, the vinyl ethers, for example octadecyl vinyl ether.

Further suitable copolymerizable monomers γ are acrylamidoglycolic acid, vinylsulfonic acid, allylsulfonic acid, methallylsulfonic acid, styrenesulfonic acid, 3-sulfopropyl acrylate, 3-sulfopropyl methacrylate and acrylamidomethylpropanesulfonic acid and monomers comprising phosphonic acid groups, such as vinylphosphonic acid, allylphosphonic acid and acrylamidomethanepropanephosphonic acid.

A further copolymerizable monomer γ which may be mentioned is diallylammonium chloride.

The specified monomers γ can be used either individually or else in the form of mixtures of two or more of the specified compounds.

The one or more further monomers γ can be used in the preparation of the copolymers to be used according to the invention in amounts of from 0 to about 49 mol %, based on the total amount of the monomers used.

In a particularly preferred embodiment, the invention provides for the use of copolymers which are obtainable by polymerization of:
a) 1 to 30 mol % of at least one monomer of the formula (I), where
   R1, R2 in each case independently of one another are H or CH₃,

R3 is phenyl which is unsubstituted or substituted with one or more identical or different substituents selected from C₁-C₉-alkyl and C₁-C₅-alkoxy, and
n is an integer from 1 to 10,
b) 50 to 99 mol % of at least one monomer chosen from the group of monomers N-vinylpyrrolidone and N-vinylcaprolactam,
c) 0 to 3 mol % of one or more different difunctional crosslinker components,
d) 0 to 3 mol % of one or more different regulators and
e) 0 to 49 mol % of at least one monomer γ,
   for increasing the systemicity of a pesticide,
   where the mol % data of the individual components must add up to 100 mol %.

The term at least one co-polymer means that one or more co-polymers as defined above can be present in the above-mentioned formulation, i.e. also mixtures of the above-defined co-polymers. Preferably, 1, 2 or 3, more preferably 1 or 2 most preferably 1 co-polymer present in the above-mentioned formulation.

In a further particularly preferred embodiment, the copolymer is based on 1 to 10 mol % (a) and 90 to 99 mol % (b).

In a further particularly preferred embodiment, n is 1 or 2.

In a further particularly preferred embodiment, (b) is N-vinylpyrrolidone.

In a further particularly preferred embodiment, the invention provides the use of copolymers which are obtainable by polymerization of:
a) 1 to 10 mol % of at least one monomer of the formula (I), where
   R1, R2 in each case independently of one another are H or CH₃,
   R3 is phenyl which is unsubstituted or substituted with one or more identical or different substituents selected from C₁-C₉-alkyl and C₁-C₅-alkoxy,
   n is 1 or 2
b) 90 to 99 mol % of vinylpyrrolidone,
c) 0 to 3 mol % of one or more different difunctional crosslinker components,
d) 0 to 3 mol % of one or more different regulators and
e) 0 to 49 mol % of at least one monomer γ,
   for increasing the systemicity of a pesticide.

In general, to increase the systemicity of a pesticide the polymer according to the invention is added to a formulation containing at least one pesticide (or vice versa). Such formulations comprise from 0.1 to 99% by weight of the polymer according to the present invention, preferably from 1 to 85% by weight, more preferably from 3 to 70% by weight, most preferably from 5 to 60% by weight.

The weight ratio of pesticide to copolymer according to the invention is preferably <6, more preferred <2, in particular ≦1.

In general, the formulations comprise from 0.1 to 90% by weight, preferably from1 to 85% by weight, of at least one pesticide, more preferably from 3 to 80% by weight, most preferably from 3 to 70% by weight.

The weight by weight ratio of polymer: pesticide is preferably 20:1-1:6 (w/w), more preferably 10:1-1:2 (w/w), most preferably 3:1-1:1 (w/w).

The term “at least one pesticide” within the meaning of the invention states that one or more compounds can be selected from the group consisting of fungicides, insecticides, nematicides, herbicide and/or safener or growth regulator, preferably from the group consisting of fungicides, insecticides or nematicides, most preferably from the group consisting of insecticides, in particular semicarbazone and phenylpyrrazole insecticides, like metaflumizone and fipronil. Also mixtures of pesticides of two or more the aforementioned classes can be used. The skilled artisan is familiar with such pesticides, which can be, for example, found in the Pesticide Manual, 14th Ed. (2006), The British Crop Protection Council, London.

The following list of pesticides is intended to illustrate the possible combinations, but not to impose any limitation:

The insecticide (which term comprises insecticides and acaricides)/nematicide is preferably selected from the group consisting of
A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
A.4. Growth regulators: a) chitin synthesis inhibitors: benzoylureas: chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
A.5. Nicotinic receptor agonists/antagonists compounds: clothianidin, dinotefuran, imidacloprid, thiamethoxam, nitenpyram, acetamiprid, thiacloprid; the thiazol compound of formula (Δ¹)

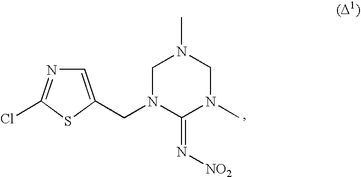

A.6. GABA antagonist compounds: acetoprole, endosulfan, ethiprole, fipronil, vaniliprole, pyrafluprole, pyriprole, the phenylpyrazole compound of formula Δ²

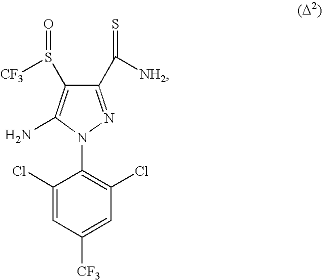

A7. Macrocyclic lactone insecticides: abamectin, emamectin, milbemectin, lepimectin, spinosad, the compound of formula (Δ³) (CAS No. 187166-40-1)

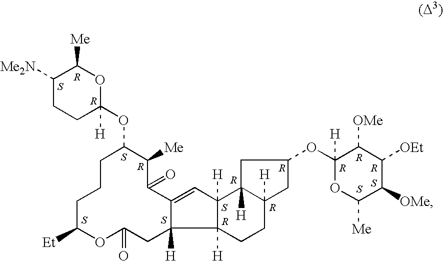

A.8. METI I compounds: fenazaquin, pyridaben, tebufenpyrad, tolfenpyrad, flufenerim;
A.9 METI II and III compounds: acequinocyl, fluacyprim, hydramethylnon;
A.10. Uncoupler compounds: chlorfenapyr;
A.11. Oxidative phosphorylation inhibitor compounds: cyhexatin, diafenthiuron, fenbutatin oxide, propargite;
A.12. Moulting disruptor compounds: cyromazine;
A.13. Mixed Function Oxidase inhibitor compounds: piperonyl butoxide;
A.14. Sodium channel blocker compounds: indoxacarb, metaflumizone,
A.15. Various: benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoquinazolinone compound of formula Δ⁴

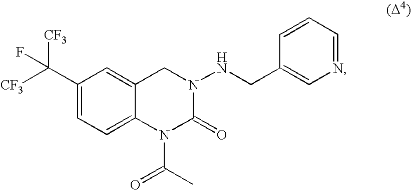

N-R′-2,2-dihalo-1-R″cyclo-propanecarboxamide-2-(2,6-dichloro-α,α,α-tri-fluoro-p-tolyl)hydrazone or N-R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, anthranilamide compounds of formula A⁵

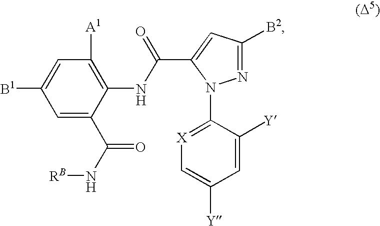

wherein Δ¹ is CH₃, Cl, Br, I, X is C—H, C—Cl, C—F or N, Y′ is F, Cl, or Br, Y″ is F, Cl, CF₃, B¹ is hydrogen, Cl, Br, I, CN, B² is Cl, Br, CF₃, OCH₂CF₃, OCF₂H, and R^{B} is hydrogen, CH₃ or CH(CH₃)₂, and malononitrile compounds as described in JP 2002 284608, WO 02/89579, WO 02/90320, WO 02/90321, WO 04/06677, WO 04/20399, or JP 2004 99597.

The commercially available compounds of the group A may be found in The Pesticide Manual, 14^{th} Edition, British Crop Protection Council (2006) among other publications. Thiamides of formula Δ² and their preparation have been described in WO 98/28279. Lepimection is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. Cyflumetofen and its preparation have been described in WO 04/080180.

Anthranilamides of formula Δ⁵ and their preparation have been described in WO 01/70671; WO 02/48137; WO 03/24222, WO 03/15518, WO 04/67528; WO 04/33468; and WO 05/118552.

Fungicides are preferably selected from the group consisting of

1. Strobilurins such as
azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methyl-pyridin-2-ylmethoxyimino)ethyl]benzyl)carbamate, methyl 2-(ortho-((2,5-dimethylphenyloxymethylene)phenyl)-3-methoxyacrylate;

2. Carboxamides such as
carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(2-cyanophenyl)-3,4-dichloroisothiazole-5-carboxamide;
carboxylic acid morpholides: dimethomorph, flumorph;
benzamides: flumetover, fluopicolide (picobenzamid), zoxamide;
other carboxamides: carpropamid, diclocymet, mandipropamid, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide; N-(3′,4′-dichloro-5-fluorobiphenyl-2-yl)-3-difluoromethyl-1-methylpyrazole-4-carboxamide and 3-Difluoromethyl-1-methyl-1H-pyrazole-4-carboxylic acid (2-bicyclopropyl-2-yl-phenyl)-amide;

3. Azoles such as
triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;

4. Nitrogenous heterocyclyl compounds such as
pyridines: fluazinam, pyrifenox, 3-[5-(4-chlorophenyl)-2,3-dimethylisoxazolidin-3-yl]-pyridine;
pyrimidines: bupirimate, cyprodinil, ferimzone, fenarimol, mepanipyrim, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
others: acibenzolar-S-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propyl-chromen-4-one, N,N-dimethyl-3-(3-bromo-6-fluoro-2-methylindole-1-sulfonyl)-[1,2,4]triazole-1-sulfonamide;

5. Carbamates and dithiocarbamates such as
dithiocarbamates: ferbam, mancozeb, maneb, metiram, metam, propineb, thiram, zineb, ziram;
carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

6. Other fungicides such as
guanidines: dodine, iminoctadine, guazatine;
antibiotics: kasugamycin, polyoxins, streptomycin, validamycin A;
organometallic compounds: fentin salts;
sulfur-containing heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorothalonil, dichlofluanid, tolylfluanid, flusulfamide, phthalide, hexachlorbenzene, pencycuron, quintozene;
nitrophenyl derivatives: binapacryl, dinocap, dinobuton;
inorganic active compounds: Bordeaux mixture, copper acetate, copper hydroxide, copper oxychloride, basic copper sulfate, sulfur;
others: spiroxamine, cyflufenamid, cymoxanil, metrafenone

Herbicides are preferably selected from the group consisting of
b1) lipid biosynthesis inhibitors such as chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate and bensulide;
b2) ALS inhibitors such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;
b3) photosynthesis inhibitors such as atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluron, anisuron, buturon, chlorbromuron, chioreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluron, phenobenzuron, siduron, tetrafluron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazone, propanil, pentanochior, pyridate, and pyridafol;
b4) protoporphyrinogen-IX oxidase inhibitors such as acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen and etnipromid;
b5) bleacher herbicides such as mefflurazon, nofflurazon, flufenican, diflufenican, picolinafen, beflubutamid, fluridone, flurochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine, and also 3-heterocyclyl-substituted benzoyl derivatives of the formula II (see in WO 96/26202, WO 97/41116, WO 97/41117 and WO 97/41118)

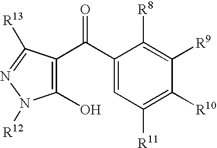

in which the variables R⁸ to R¹³ are as defined below:

R⁸, R¹⁹ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;

R⁹ is a heterocyclic radical selected from the group consisting of such as thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the nine radicals mentioned may be unsubstituted or mono- or polysubstituted, e.g. mono-, di-, tri- or tetrasubstituted, by halogen, C₁-C₄-alkyl, C₁-C₄-alkoxy, C₁-C₄-haloalkyl, C₁-C₄-haloalkoxy or C₁-C₄-alkylthio;

R¹¹ is hydrogen, halogen or C₁-C₆-alkyl;

R¹² is C₁-C₆-alkyl;

R¹³ is hydrogen or C₁-C₆-alkyl.

b6) EPSP synthase inhibitors such as glyphosate;

b7) glutamine synthase inhibitors such as glufosinate and bilanaphos;

b8) DHP synthase inhibitors such as asulam;

b9) mitose inhibitors such as benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;

b10) VLCFA inhibitors such as acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;

b11) cellulose biosynthesis inhibitors such as dichlobenil, chlorthiamid, isoxaben and flupoxam;

b12) decoupler herbicides such as dinofenate, dinoprop, dinosam, dinoseb, dinoterb, DNOC, etinofen and medinoterb;

b13) auxin herbicides such as clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluroxypyr, picloram, triclopyr and benazolin;

b14) auxin transport inhibitors such as naptalam, diflufenzopyr;

b15) benzoylprop, flamprop, flamprop-M, bromobutide, chlorflurenol, cinmethylin, methyldymron, etobenzanid, fosamine, metam, pyributicarb, oxaziclomefone, dazomet, triaziflam and methyl bromide.

Suitable safeners can be selected from the following listing: benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67; MON 4660) and oxabetrinil

Generally, fungicides and insecticides are preferred.

Preferred insecticides are azinphos-methyl, chlorpyrifos, chlorpyrifos-methyl, chlorfenvinphos, diazinon, disulfoton, ethion, fenitrothion, fenthion, isoxathion, malathion, methidathion, methyl-parathion, parathion, phenthoate, phosalone, phosmet, phorate, phoxim, pirimiphos-methyl, profenofos, prothiofos, suiprophos, tetrachlorvinphos, terbufos, alanycarb, benfuracarb, carbosulfan, fenoxycarb, furathiocarb, methiocarb, triazamate; chlorfluazuron, diflubenzuron, flucycloxuron, flufenoxuron, hexaflumuron, lufenuron, novaluron, teflubenzuron, triflumuron; methoxyfenozide, tebufenozide, azadirachtin pyriproxyfen, methoprene, fenoxycarb; spirodiclofen, spiromesifen, spirotetramat; clothianidin, dinotefuran, imidacloprid, thiamethoxam, nitenpyram, acetamiprid, thiacloprid; acetoprole, endosulfan, ethiprole, fipronil, vaniliprole, pyrafluprole, pyriprole, the phenylpyrazole compound of formula Δ²

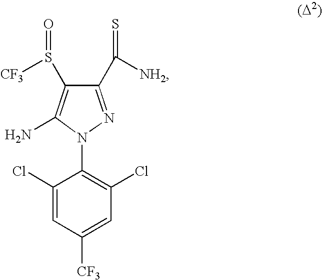

abamectin, emamectin, milbemectin, lepimectin, fenazaquin, pyridaben, tebufenpyrad, acequinocyl, fluacyprim, hydramethylnon, chlorfenapyr, cyhexatin, diafenthiuron, fenbutatin oxide, propargite;, piperonyl butoxide; indoxacarb, metaflumizone, bifenazate, pymetrozine, N-R′-2,2-dihalo-1-R″cyclo-propanecarboxamide-2-(2,6-dichloro-α,α,α-tri-fluoro-p-tolyl)hydrazone or N-R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl

More preferred insecticides are cyfluthrin, γ-cyhalothrin, cypermethrin, alpha-cypermethrin, beta-cypermethrin, deltamethrin, esfenvalerate, fenvalerate, permethrin, tefluthrin, tetramethrin, transfluthrin, flufenoxuron, teflubenzuron, clothianidin, thiamethoxam, acetamiprid, ethiprole, fipronil, phenylpyrazole compound of formula Δ²

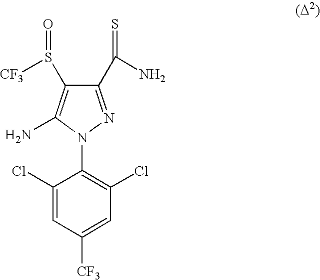

chlorfenapyr; piperonyl butoxide;: indoxacarb, metaflumizone, pymetrozine, N-R′-2,2-dihalo-1-R″cyclo-propanecarboxamide-2-(2,6-dichloro-α,α,α-tri-fluoro-p-tolyl)hydrazone or N-R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl.

Most preferred are fipronil and metaflumizone, in particular fipronil.

Preferred fungicides are are azoxystrobin, dimoxystrobin, fluoxastrobin, kresoximmethyl, picoxystrobin, pyraclostrobin, trifloxystrobin, orysastrobin, methyl 2-(ortho-((2,5-dimethylphenyloxymethylene)phenyl)-3-methoxyacrylate; boscalid, metalaxyl, penthiopyrad, N-(3′,4′-dichloro-4-fluorobiphenyl-2-yl)-3-difluoromethyl-1-methylpyrazole-4-carboxamide, dimethomorph, fluopicolide (picobenzamid), zoxamide; mandipropamid, N-(3′,4′-dichloro-5-fluorobiphenyl-2-yl)-3-difluoromethyl-1-methylpyrazole-4-carboxamide, 3-Difluoromethyl-1-methyl-1H-pyrazole-4-carboxylic acid (2-bicyclopropyl-2-yl-phenyl)-amide, cyproconazole, difenoconazole, epoxiconazole, fluquinconazole, metconazole, propiconazole, prothioconazole, tebuconazole, triticonazole; cyazofamid, prochloraz, ethaboxam, fluazinam, cyprodinil, pyrimethanil; triforine; fludioxonil, dodemorph, fenpropimorph, tridemorph, vinclozolin, dazomet, fenoxanil, fenpropidin, proquinazid; flubenthiavalicarb, iprovalicarb, dodine, dithianon, fosetyl, fosetyl-aluminum, chlorothalonil, spiroxamine, cyflufenamid, cymoxanil, metrafenone.

More preferred fungicides are azoxystrobin, dimoxystrobin, fluoxastrobin, kresoximmethyl, picoxystrobin, pyraclostrobin, trifloxystrobin, orysastrobin,boscalid, metalaxyl, N-(3′,4′-dichloro-4-fluorobiphenyl-2-yl)-3-difluoromethyl-1-methylpyrazole-4-carboxamide, dimethomorph, fluopicolide (picobenzamid), zoxamide; mandipropamid, N-(3′,4′-dichloro-5-fluorobiphenyl-2-yl)-3-difluoromethyl-1-methylpyrazole-4-carboxamide, 3-Difluoromethyl-1-methyl-1H-pyrazole-4-carboxylic acid (2-bicyclopropyl-2-yl-phenyl)-amide, cyproconazole, difenoconazole, epoxiconazole, metconazole, propiconazole, prothioconazole, tebuconazole, cyazofamid, prochloraz, cyprodinil, triforine; fludioxonil, dodemorph, fenpropimorph, tridemorph, vinclozolin, dazomet, fenoxanil, iprovalicarb, dodine, dithianon, fosetyl, fosetyl-aluminum, chlorothalonil, spiroxamine, metrafenone.

Most preferred fungicides are azoxystrobin, fluoxastrobin, picoxystrobin, pyraclostrobin, trifloxystrobin, orysastrobin,boscalid, metalaxyl, N-(3′,4′-dichloro-4-fluorobiphenyl-2-yl)-3-difluoromethyl-1-methylpyrazole-4-carboxamide, dimethomorph, fluopicolide (pico-benzamid), zoxamide; mandipropamid, 3-Difluoromethyl-1-methyl-1H-pyrazole-4-carboxylic acid (2-bicyclopropyl-2-yl-phenyl)-amide, cyproconazole, difenoconazole, epoxiconazole, propiconazole, prothioconazole, tebuconazole, prochloraz, cyprodinil, fludioxonil, iprovalicarb, fosetyl, fosetyl-aluminum, chlorothalonil, spiroxamine, metrafenone.

As mentioned above, in one embodiment of the invention, also pesticides can be used, which confer plant health effects. Such pesticides are known in the art. Suitable for this purpose are, for example
an active compound that inhibits the mitochondrial breathing chain at the level of the b/c1 complex;
carboxylic amides selected from benalaxyl, benodanil, boscalid, carboxin, mepronil, fenfuram, fenhexamid, flutolanil, furametpyr, metalaxyl, of urace, oxadixyl, oxycarboxin, penthiopyrad, thifluzamid, tiadinil, 4-difluoromethyl-2-methyl-thiazol-5-carboxylic acid-(4′-bromo-biphenyl-2-yl)-amide, 4-difluoromethyl-2-methyl-thiazol-5-carboxylic acid-(4′-trifluoromethyl-biphenyl-2-yl)-amide, 4-difluoromethyl-2-methyl-thiazol-5-carboxylic acid-(4′-chloro-3′-fluoro-biphenyl-2-yl)-amide, 3-difluoromethyl-1-methyl-pyrazol-4-carboxylic acid-(3′,4′-dichloro-4-fluoro-biphenyl-2-yl)-amide, 3,4-dichloro-isothiazol-5-carboxylic acid-(2-cyano-phenyl)-amide, dimethomorph, flumorph, flumetover, fluopicolide (picobenzamid), zoxamide, carpropamide, diclocymet, mandipropamid, N-(2-(4-[3-(4-chloro-phenyl)-prop-2-inyloxy]-3-methoxy-phenyl)-ethyl)-2-methanesulfonylamino-3-methyl-butyramid and N-(2-(4-[3-(4-chloro-phenyl)-prop-2-inyloxy]-3-methoxy-phenyl)-ethyl)-2-ethanesulfonylamino-3-methyl-butyramide;
azoles selected from bitertanole, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole, cyazofamid, imazalil, pefurazoate, prochloraz, triflumizol, benomyl, carbendazim, fuberidazole, thiabendazole, ethaboxam, etridiazole and hymexazole;
nitrogen-containing heterocyclic compounds selected from fluazinam, pyrifenox, 3-[5-(4-chloro-phenyl)-2,3-dimethyl-isoxazolidin-3-yl]-pyridine, bupirimat, cyprodinil, ferimzon, fenarimol, mepanipyrim, nuarimol, pyrimethanil, triforin, fludioxonil, fenpiclonil, aldimorph, dodemorph, fenpropimorph, tridemorph, iprodion, procymidon, vinclozolin, acibenzolar-S-methyl, anilazin, captan, captafol, dazomet, diclomezine, fenoxanil, folpet, fenpropidin, famoxadone, fenamidone, octhilinon, probenazol, proquinazid, pyroquilon, quinoxyfen, tricyclazol, 2-butoxy-6-iodo-3-propyl-chromen-4-one, 3-(3-bromo-6-fluoro-2-methyl-indole-1-sulfonyl)[1,2,4]triazole-1-sulfonic acid dimethylamide;
carbamates and dithiocarbamates selected from ferbam, mancozeb, metiram, metam, propineb, thiram, zineb, ziram, diethofencarb, flubenthiavalicarb, iprovalicarb, propamocarb, 3-(4-chloro-phenyl)-3-(2-isopropoxycarbonylamino-3-methyl-butyrylamino)-propionic acid methylester and N-(1-(1-(4-cyanophenyl)ethanesulfonyl)-but-2-yl) carbamic acid -(4-fluorophenyl)ester;
guanidines selected from dodin, iminoctadine and guazatin;
antibiotics selected from kasugamycin, polyoxine, streptomycin and validamycin A;
fentin salts;
sulfur-containing heterocyclic compounds selected from isoprothiolan and dithianon;
organophosphorous compounds selected from edifenphos, fosetyl, fosetyl-aluminium, iprobenfos, pyrazophos, tolclofos-methyl, phosphoric acid and the salts thereof;
organo-chloro compounds selected from thiophanate methyl, chlorothalonil, dichlofluanid, tolylfluanid, flusulfamid, phthalide, hexachlorbenzene, pencycuron, quintozen;
nitrophenyl derivatives selected from binapacryl, dinocap and dinobuton;
inorganic active ingredients selected from Bordeaux composition, copper acetate, copper hydroxide, copper oxychloride, basic copper sulfate and sulfur;
spiroxamine; cyflufenamide; cymoxanil; metrafenone;
organo(thio)phosphates selected from acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos and trichlorfon;
carbamates selected from alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicar and triazamate;
pyrethroids selected from allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin and profluthrin, dimefluthrin;
growth regulators selected from a) chitin synthesis inhibitors that are selected from the benzoylureas chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole and clofentazine; b) ecdysone antagonists that are selceted from halofenozide, methoxyfenozide, tebufenozide and azadirachtin; c) juvenoids that are selected from pyriproxyfen, methoprene and fenoxycarb and d) lipid biosynthesis inhibitors that are selected from spirodiclofen, spiromesifen and spirotetramat;
nicotinic receptor agonists/antagonists compoundsselected from clothianidin, dinotefuran, (EZ)-1-(6-chloro-3-pyridylmethyl)-N-nitroimidazolidin-2-ylideneamine (imidacloprid), (EZ)-3-(2-chloro-1,3-thiazol-5-ylmethyl)-5-methyl-1,3,5-oxadiazinan-4-ylidene(nitro)amine (thiamethoxam), nitenpyram, acetamiprid, thiacloprid;
the thiazol compound of formula (Γ¹)

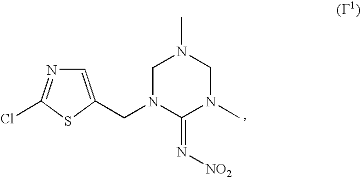

GABA antagonist compoundsselected from acetoprole, endosulfan, ethiprole, 5-amino-1-(2,6-dichloro-α,α,α-trifluoro-p-tolyl)-4-trifluoromethylsulfinylpyrazole-3-carbonitrile (fipronil), vaniliprole, pyrafluprole, pyriprole and the phenylpyrazole compound of formula Γ²

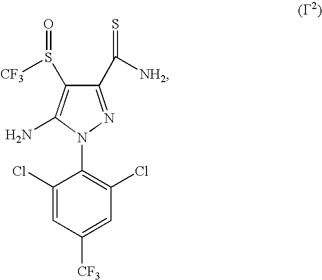

METI I compounds selected from tenazaquin, pyridaben, tebufenpyrad, tolfenpyrad and flufenerim;
METI II and III compounds selected from acequinocyl, fluacyprim and hydramethylnon; chlorfenapyr;
oxidative phosphorylation inhibitor compounds selected from cyhexatin, diafenthiuron, fenbutatin oxide and propargite;
cyromazine; piperonyl butoxide; indoxacarb; benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoquinazolinone compound of formula Γ⁴

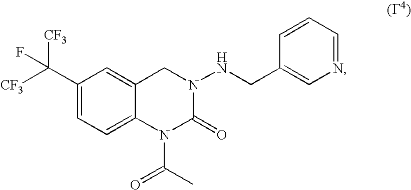

and anthranilamide compounds of formula Γ⁵

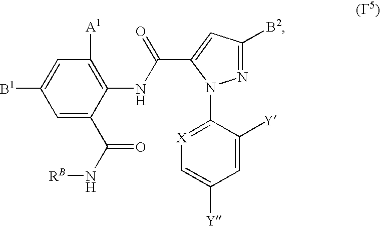

wherein A¹ is CH₃, Cl, Br, I, X is C—H, C—Cl, C—F or N, Y′ is F, Cl, or Br, Y″ is F, Cl, CF₃, B¹ is hydrogen, Cl, Br, I, CN, B² is Cl, Br, CF₃, OCH₂CF₃, OCF₂H, and R^{B} is hydrogen, CH₃ or CH(CH₃)₂.
wherein pyraclostrobin, azoxystrobin, kresoximmetyl, trifloxystrobin, picoxystrobin, dimoxystrobin, fluoxastrobin, orysastrobin, tebuconazole, difenoconazole, epoxiconazole, cyproconazole, prothioconazole, propiconazole, fipronil, imidacloprid and thiamethoxam are preferred.

As set forth above, the polymers according to the present invention can be used for the preparation of formulations comprising at least one pesticide and the polymer according to the present invention. Optionally, formulations comprising at least one pesticide and at least one polymer according to the present invention may comprise further formutation auxiliaries.

The formulations containing a polymer according to the invention in order to increase the systemicity of a pesticide are partly new.

Accordingly, in a further aspect of the invention there is provided a pesticidal formulation comprising
A. 0.1 to 95% (by weight) of one or more copolymer wich is obtainable by polymerization of:
   a) 1 to 30 mol % of at least one monomer of the formula (I), where
      R1, R2 in each case independently of one another are H or CH₃,
      R3 is phenyl which is unsubstituted or substituted with one or more identical or different substituents selected from C₁-C₉-alkyl and C₁-C₅-alkoxy,
      n is an integer from 1 to 10,
   b) 50 to 99 mol % of N-vinylpyrrolidone,
   c) 0 to 30 mol % of one or more different difunctional crosslinker components,
   d) 0 to 3 mol % of one or more different regulators and
   e) 0 to 49 mol % of at least one further monomer,
   where the mol % data of the individual components must add up to 100 mol %,
B. 0.1 to 85% (by weight) of one or more pesticide selected from the group consisting of insecticides and fungicides, preferably phenylpyrazole insecticides and semicarbazone insecticides, in particular fipronil and metaflumizone, and
C. 0 to 70% by weight of one or more formulation auxiliaries, wherein the weight ratio of B:A is <6, preferably <2≦1.

In general, the formulations comprise from 0 to 90% by weight, preferably from 1 to 85% by weight, more preferably from 5 to 80% by weight, most preferably from 5 to 65% by weight of the formulation auxiliaries.

The term “formulation auxiliaries” within the meaning of the invention is auxiliaries suitable for the formulation of pesticides, such as further solvents and/or carriers and/or surfactants (ionic or non-ionic surfactants, adjuvants, dispersing agents) and/or preservatives and/or antifoaming agents and/or anti-freezing agents and optionally, for seed treatment formulations colorants and/or binders and/or gelling agents and/or thickeners.

Examples of suitable solvents are water, aromatic solvents (for example Solvesso products, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gammabutyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Examples of suitable carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.

Also anti-freezing agents such as glycerin, ethylene glycol, hexylene glycol, propylene glycol and bactericides such as can be added to the formulation.

Suitable antifoaming agents are for example antifoaming agents based on silicon or magnesium stearate.

Suitable preservatives are for example 1,2-benzisothiazolin-3-one and/or 2-Methyl-2H-isothiazol-3-one or sodium benzoate or benzoic acid.

Examples of thickeners (i.e., compounds which bestow a pseudoplastic flow behavior on the formulation, i.e. high viscosity at rest and low viscosity in the agitated state) are, for example, polysaccharides or organic or inorganic layered minerals, such as xanthan gum (Kelzan® from Kelco), Rhodopol® 23 (Rhone-Poulenc) or Veegum® (R.T. Vanderbilt) or Attaclay® (Engelhardt).

Seed treatment formulations may additionally comprise binders and optionally colorants.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Binders can be added to improve the adhesion of the active materials on the seeds after treatment. Suitable binders are: polyvinylpyrrolidone, polyvinylacetate, polyvinylalkohol and tylose.

The use forms of the formulations (for example in the form of directly sprayable solutions, powders, suspensions or dispersions, emulsions, oil dispersions, pastes, dustable products, materials for spreading, or granules) depend entirely on the intended purposes; they are intended to ensure in each case the finest possible distribution of the pesticide and polymer according to the invention.

Examples of suitable formulation types in which the polymer according to the present invention can be used are

1. Liquid Formulations such as
EC (Emulsifiable concentrate) formulation; SL or LS (Soluble concentrate) formulation; EW (Emulsion, oil in water) formulation ME (Microemulsion) formulation MEC Microemulsifiable concentrates concentrate formulation CS (Capsule suspension) formulation TK (Technical concentrate) formulation, OD (oil based suspension concentrate) formulation; SC (suspension concentrate) formulation; SE (Suspo-emulsion) formulation; ULV (Ultra-low volume liquid) formulation; SO (Spreading oil) formulation; AL (Any other liquid) formulation; LA (Lacquer) formulation; DC (Dispersible concentrate) formulation;

2. Solid Formulations such as
WG (Water dispersible granules) formulation; TB (Tablet) formulation; FG (Fine granule) formulation; MG (Microgranule) formulation; SG (soluble Granule)

Preferred are formulation types such as EC (Emulsifiable concentrate) formulation; SL or LS (Soluble concentrate) formulation; EW (Emulsion, oil in water) formulation ME (Microemulsion) formulation,CS (Capsule suspension) formulation, OD (oil based suspension concentrate) formulation; SC (suspension concentrate) formulation; SE (Suspo-emulsion) formulation; DC (Dispersible concentrate) formulation, WG (Water dispersible granules) formulation; TB (Tablet) formulation); FG (Fine granule) formulation and SG (soluble Granule).

The processes for the preparation of a formulation according to the present invention are generally familiar to a person skilled in the art and are, for example, described in the literature cited with the various formulation types (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8).

Liquid formulations can be prepared by mixing or combining the polymer according to the invention with at least one pesticide and or further formulation auxiliaries.

Powders, materials for spreading and dustable products can be prepared by mixing or concomitantly grinding the active substances with a solid carrier.

Granules, for example coated granules, impregnated granules, and homogeneous granules, can be prepared by binding the active compounds to solid carriers.

The above-referred formulations can be used as such or use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the pesticid(es) and polymer according to the invention.

Aqueous use forms can be prepared also from emulsion concentrates, pastes or wettable powders (sprayable powders, oil dispersions) by adding a suitable solvent, for example water.

In general, the polymer according to the present invention can be added to an already prepared formulation or included in a formulation comprising at least one pesticide and at least one polymer according to the present invention. The addition of the polymer to the formulation can be performed prior or after dilution of the formulation in water; e.g. preparing a formulation as mentioned before containing the polymer according to this invention or adding the polymer after dilution of the pesticide formulation in a suitable solvent, for example water (e.g. as so called tank mix).

All embodiments of the above-mentioned application are herein below referred to as the use according to the present invention.

The present invention furthermore comprises a method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the new agrochemical formulation.

The formulations according to the invention can be used for the control of a multitude of phytopaghogenic fungi or insects on various cultivated plants or weeds in such crops as, for example wheat, rye, barley, oats, rice, corn, grass, bananas, cotton, soya, coffee, sugar cane, vines, fruits and ornamental plants, and vegetables, such as cucumbers, beans, tomatoes, potatoes and cucurbits, and on the seeds of these plants.

The invention furthermore provides for a method of improving the health of plants, which comprises applying the new formulation according to the invention, wherein the pesticide is a pesticide which confers plant health effects, to plants, parts of plants, or the locus where plants grow.

The invention furthermore provides a method of controlling undesired vegetation, which comprises allowing a herbicidally effective amount of the new agrochemical formulation according to the invention to act on plants, their habitat or on seed of said plants.

Thus, the formulations are suitable for controlling common harmful plants in useful plants, in particular in crops such as oat, barley, millet, corn, rice, wheat, sugar cane, cotton, oilseed rape, flax, lentil, sugar beet, tobacco, sunflowers and soybeans or in perennial crops.

The term phytopathogenic fungi includes but is not limited to the following species:

Alternaria species on vegetables, rapeseed, sugar beet and fruit and rice (for example A. solani or A. alternata on potato and other plants); Aphanomyces species on sugar beet and vegetables; Bipolaris and Drechslera species on corn, cereals, rice and lawns (for example D. teres on barley, D. tritci-repentis on wheat); Blumeria graminis (powdery mildew) on cereals; Botrytis cinerea (gray mold) on strawberries, vegetables, flowers and grapevines; Bremia lactucae on lettuce; Cercospora species on corn, soybeans, rice and sugar beet (for example C. beticula on sugar beet); Cochliobolus species on corn, cereals, rice (for example Cochliobolus sativus on cereals, Cochliobolus miyabeanus on rice); Colletotricum species on soybeans, cotton and other plants (for example C. acutatum on various plants); Esca on grapes caused by Phaeoacremonium chlamydosporium, Ph. Aleophilum, and Formitipora punctata (syn. Phellinus punctatus); Exserohilum species on corn; Erysiphe cichoracearum and Sphaerotheca fuliginea on cucurbits; Fusarium and Verticillium species (for example V. dahliae) on various plants (for example F. graminearum on wheat); Gaeumanomyces graminis on cereals; Gibberella species on cereals and rice (for example Gibberella fujikuroi on rice); Grainstaining complex on rice; Helminthosporium species (for example H. graminicola) on corn and rice; Michrodochium nivale on cereals; Mycosphaerella species on cereals, bananas and peanuts (M. graminicola on wheat, M. fijiesis on bananas); Phakopsara pachyrhizi and Phakopsara meibomiae on soybeans; Phomopsis species on soybeans, sunflowers and grapevines (P. viticola on grapevines, P. helianthii on sunflowers); Phytophthora infestans on potatoes and tomatoes; Plasmopara viticola on grapevines; Podosphaera leucotricha on apples; Pseudocercosporella herpotrichoides on cereals; Pseudoperonospora species on hops and cucurbits (for example P. cubenis on cucumbers); Puccinia species on cereals, corn and asparagus (P. triticina and P. striformis on wheat, P. asparagi on asparagus); Pyrenophora species on cereals; Pyricularia oryzae, Corticium sasakii, Sarocladium oryzae, S. attenuatum, Entyloma oryzae on rice; Pyricularia grisea on lawns and cereals; Pythium , spp. on lawns, rice, corn, cotton, rapeseed, sunflowers, sugar beet, vegetables and other plants; Rhizoctonia-species (for example R. solani) on cotton, rice, potatoes, lawns, corn, rapeseed, potatoes, sugar beet, vegetables and other plants; Rhynchosporium secalis e.g. on rye and barley; Sclerotinia species (for example S. sclerotiorum) on rapeseed, sunflowers and other plants; Septoria tritici and Stagonospora nodorum on wheat; Erysiphe (syn. Uncinula necator) on grapevines; Setospaeria species on corn and lawns; Sphacelotheca reilinia on corn; Thievaliopsis species on soybeans and cotton; Tilletia species on cereals; Ustilago species on cereals, corn and sugar beet and; Venturia species (scab) on apples and pears (for example V. inaequalis on apples). They are particularly suitable for controlling harmful fungi from the class of the Oomycetes, such as Peronospora species, Phytophthora species, Plasmopara viticola and Pseudoperonospora species.

The formulations according to the present invention can also be used for controlling harmful fungi in the protection of material such as wood. Examples of fungi are Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp.

The invention furthermore relates to a method for controlling undesirable vegetation in crops, in particular in crops of oat, barley, millet, corn, rice, wheat, sugar cane, cotton, oilseed rape, flax, lentil, sugar beet, tobacco, sunflowers and soybeans or in perennial crops, which comprises allowing a effective amount of a agrochemical formulation according to the present invention to act on plants, their habitat or on seed of said plants.

The invention furthermore relates to a method for controlling undesirable vegetation in crops which, by genetic engineering or by breeding, are resistant to one or more herbicides and/or fungicides and/or or to attack by insects, which comprises allowing a effective amount of a agrochemical formulation according to the present invention to act on plants, their habitat or on seed of said plants.

The control of undesired vegetation is understood as meaning the destruction of weeds. Weeds, in the broadest sense, are understood as meaning all those plants which grow in locations where they are undesired, for example:

Dicotyledonous weeds of the genera: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

Monocotyledonous weeds of the genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemurn, Sphenoclea, Dactyloctenium, Agrostis, Alopecurus, Apera.

Pests, like insects, arachnids and nematodes that can be controlled according to the invention include: insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa,

thrips (Thysanoptera), e.g. Dichromothrips corbetti, Dichromothrips ssp , Frankliniella fusca, Frankliniella occidentalis, Frankliniella tritici, Scirtothrips citri, Thrips oryzae, Thrips palmi and Thrips tabaci,

termites (Isoptera), e.g. Calotermes flavicollis, Leucotermes flavipes, Heterotermes aureus, Reticulitermes flavipes, Reticulitermes virginicus, Reticulitermes lucifugus, Termes natalensis, and Coptotermes formosanus,

cockroaches (Blattaria-Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,

true bugs (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis , Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus,

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminif era, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa,

fleas (Siphonaptera), e.g. Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Scutigera coleoptrata,

millipedes (Diplopoda), e.g. Narceus spp.,

Earwigs (Dermaptera), e.g. forficula auricularia,

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus,

Plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species.

Thus, as set forth above, formulations according to the invention can be applied via various methods.

In one embodiment of the present invention, foliar application of the formulation according to the present invention is carried out, e.g. by spraying or dusting or otherwise applying the mixture to the seeds, the seedlings, or the plants.

Another embodiment of the present invention comprises soil treatment, e.g by spraying or dusting or otherwise applying the mixture to the soil before (e.g. by soil drench) or after sowing of the plants or before or after emergence of the plants.

In accordance with one variant of soil application, a further subject of the invention is a method of treating soil by the application, in particular into the seed drill.

In accordance with one variant of soil application, a further subject of the invention is in furrow treatment, which comprises adding a solid or liquid formulation to the open furrow, in which seeds have been sown or, alternatively, applying seeds and formulation simultaneously to the open furrow

Another embodiment of the invention comprises the treatment of seeds or seedlings from plants with the new formulation of the invention.

The term seed treatment comprises all suitable seed treatment techniques known in the art, such as seed dressing, seed coating, seed dusting, seed soaking and seed pelleting.

Thus, the application of the new formulation according to the invention is carried out by spraying or dusting or otherwise applying the formulation according to the invention to the seeds or the seedlings.

The invention also comprises seeds coated with the new formulation of the invention.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

Suitable seed is seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the formulation according to the invention may also be used for the treatment seeds from plants, which tolerate the action of herbicides or fungicides or insecticides owing to breeding, including genetic engineering methods, for example seeds of transgenic crops which are resistant to herbicides from the group consisting of the sulfonylureas (EP-A-0257993, U.S. Pat. No. 5,013,659), imidazolinones (see for example U.S. Pat. No. 6,222,100, WO0182685, WO0026390, WO9741218, WO9802526, WO9802527, WO 04/106529, WO 05/20673, WO 03/14357, WO 03/13225, WO 03/14356, WO 04/16073), glufosinate-type (see for example EP-A-0242236, EP-A-242246) or glyphosate-type (see for example WO 92/00377) or in seeds of plants resistant towards herbicides selected from the group of cyclohexadienone/aryloxyphenoxypropionic acid herbicides (U.S. Pat. No. 5,162,602 , U.S. Pat. No. 5,290,696 , U.S. Pat. No. 5,498,544 , U.S. Pat. No. 5,428,001 , U.S. Pat. No. 6,069,298 , U.S. Pat. No. 6,268,550 , U.S. Pat. No. 6,146,867 , U.S. Pat. No. 6,222,099 , U.S. Pat. No. 6,414,222) or in seeds of transgenic crop plants, for example cotton, with the capability of producing Bacillus thuringiensis toxins (Bt toxins) which make the plants resistant to certain pests (EP-A-0142924, EP-A-0193259).

The seed treatment application of a formulation according to the invention is carried out by spraying or dusting the seeds before sowing of the plants and before emergence of the plants by methods known to the skilled artisan.

In the treatment of seeds the corresponding formulations are applied by treating the seeds with an effective amount of the formulation according to the present invention. Herein, the application rates of pesticide are generally from 0,1 g to 10 kg per 100 kg of seed, preferably from 1 g to 5 kg per 100 kg of seed, in particular from 1 g to 2,5 kg per 100 kg of seed. For specific crops such as lettuce or onion, the rate can be higher.

For the purpose of the invention, seed treatment and soil (or habitat of plant) treatment is preferred.

The invention is further illustrated but not limited by the following examples.

### EXAMPLES

Abbreviations used
HPLC high pressure liquid chromatography
M molecular weight
MS mass spectronomy
PEGPEA poly(ethylenglycol)phenyletheracrylate
POEA phenoxyethylacrylate
tBPPiv tert.-butylperpivalate
VP vinylpyrrolidone
Wako V50 2,2′-azobis(2-amidinopropan)dihydrochloride

Polymer Synthesis

To prepare the polymers, the following, apparatus was used:
21 apparatus with process controlled water-bath, anchor stirrer and thermometer. The apparatus had connectors for 3 feeds, a reflux condenser and an inlet tube for introducing nitrogen or steam.

Polymer A

Preparation of a VP/POEA (96/4 wt %) copolymer:

The initial charge (420 g water, 0.4 g Wako V 50, 420 g ethanol, 1.6 g POEA, 34.4 g VP) was gassed with nitrogen and heated to a reactor internal temperature of 75° C. Then feed 1 (12.8 g POEA, 60 g water, 311.2 g VP, 60 g ethanol) and feed 2 (70.8 g water, 70.8 g ethanol, 3.2 g Wako V 50) were started. Feed 1 was introduced in 4 h, feed 2 was introduced in the course of 5 h. The reaction mixture was then kept at 75° C. for additional 2 h. The polmer was then subject to vapour distillation to replace ethanol by water.

One obtained an opaque polymer solution in water with a solid content of 25% and a k-value of 31.

Polymer B

Preparation of a VP/PEGPEA (M=280 g/mol) (90/10 wt %) copolymer:

The initial charge (100 g isopropanol, 5 g VP) was gassed with nitrogen and heated to a reactor internal temperature of 80° C. Then feed 1 (10 g PEGPEA, 200 g isopropanol), feed 2 (85 g VP, 200 g isopropanol) and feed 3 (50 g isopropanol, 4 g tBPPiv) were started. Feed 1 was introduced in 5 h, feed 2 in 5.5 h and feed 3 was introduced in the course of 6 h. The reaction mixture was then kept at 80° C. for additional 1 h. The polymer was then dried in a vaccum cabinet dryer.

One obtains a white powder of k-value 13.7.

Application Tests

### Example 1

To test the root systemicity of fipronil with polymers according to the invention, wheat plants in vermiculite were drenched with 20 ml fipronil/polymer (1:1 wt) solutions in Hoagland solution/acetone mixtures (0.6 v % acetone). Two fipronil and polymer concentrations were used, 3 ppm and 6 ppm. As reference fipronil solutions in Hoagland solution/acetone mixtures without polymer were used. Hoagland solution consists of the following ingredients:

0.25 v % of 1M KNO₃ solution in water, 0.1 v % of 1 M MgSO₄ solution in water, 0.05 v % of 1M KH₂PO₄ solution in water, 0.25 v % 1M Ca(NO₃)₂) solution in water, 0.05 v % of a trace solution consisting of 2.86 g/l H₃BO₃, 1.81 g/l MnCl₂*4H₂O, 0.22 g/l ZnSO₄*7H₂O, 0.08 g/l CuSO₄*5H₂O, 0.016 g/l MoO₃ in water, 0.075 v % Sequestrene 138 Fe consisting of 30 g/l sodium ferric ethylenediamine di-(o-hydroxyphenylacetate) in water, 99.225 v % water sterilized and pH adjusted to 6-6.5 with NaOH.

The plants were then infested with aphids. After 4 days the aphid population on the wheat plants was counted. The results of fipronil and fipronil with polymer are related to the aphid population on plants that had not been treated with fipronil.

Results are presented in Table 1 and 2:

TABLE 1

| | Concentration [ppm] | Aphid population |
|---|---|---|
| Not treated | 0 | 100% |
| Reference A | 3 | 51% |
| | 6 | 23% |
| Reference B | 3 | 3% |
| | 6 | 0% |

TABLE 2

| | Concentration [ppm] | Aphid population |
|---|---|---|
| Not treated | 0 | 100% |
| Reference A | 3 | 23% |
| | 6 | 12% |
| Reference B | 3 | 4% |
| | 6 | 3% |

The results show that with the polymers A and B, significant improved pest control was achieved for both concentrations.

### Example 2

To test the polymers, 100 μL COSMO 50 FS (commercial formulation, containing 500 g/l Fipronil) was mixed with 1100 μl of a 4.5 wt % polymer solution in water. As a reference (“COSMO 50 FS without polymer”) a mixture of 100 μl COSMO 50 FS in 1100 μl water was used. Then 100 sugar beet seeds were treated twice with 300 μl polymer/COSMO 50 FS mixture (corresponding to 25 g Fipronil/100 kg seed and 25 g polymer/100 kg seed), and another 100 seeds were treated twice with 300 μl of the reference (“COSMO 50 FS without polymer”).

The seeds of sugar-beets were sown in soil containing styropor-boxes under greenhouse conditions. Samples were taken at a plant height of about 10-15 cm. After sampling the plants (both treatment groups) were subdivided into two segments (hypocotyls and rest of plant). The samples were frozen immediately after sampling and kept frozen until analysis. Prior to analysis the sample material was homogenized using a Stephansmill in the presence of dry ice resulting in very small sample particles.

Fipronil was extracted from plant matrices using a mixture of methanol and water. For clean-up a liquid/liquid partition against dichloromethane was used. The final determination of fipronil content was performed by HPLC-MS/MS.

Results are presented in table 3:

TABLE 3

| | | Fipronil concentration |
|---|---|---|
| | | [ppm] |
| COSMO 50 FS without | Hypocotyl | 0.1836 |
| polymer | Rest of plant | 0.0624 |
| COSMO 50 FS with polymer A | Hypocotyl | 2.4506 |
| | Rest of plant | 0.1198 |

The results show that with the polymer A, significant improved root uptake was achieved in seed treatment experiments.

### Example 3

### Comparative Test

Abbreviations
ai active ingredient
AM acrylamide
CHEAL Chenopodium album

Preparation of Comparative Polymer C (Poly Acrylamide)

The initial charge (80 g water) was gassed with nitrogen and heated to a reactor internal temperature of 100° C. Then feed 1 (100 g AM, 3.4 g Trilon C), feed 2 (20 g water, 8.47 g sodium hypophosphite) and feed 3 (10.5 g water, 1.5 g sodium peroxodisulphate) were started. Feed 1 was introduced in 3 h, feed 2 in 2 h. ⅔ of feed 3 were introduced in the course of 3 h the rest in 30 minutes. The reaction mixture was then kept at 100° C. for an additional hour.

A clear polymer solution in water with a solid content of 25% and a k-value of 20 was obtained

Application Test

To test an increased uptake of the herbicide metazachlor with the help of polymers Chenopodium album (CHEAL) plants were cultivated in trays under green house conditions. The polymers (polymer A and comparative polymer C) were mixed with the commercial metazachlor formulation Butisan S® (500 g metazachlor per liter, to obtain a polymer to ai ratio of 1:1 in water. Application rates used were 187.5, 93.75, 46.87 and 23.44 g ai/ha.

6 days after emergence 5 ml of metazachlor/polymer mixture per tray were directly applied to the soil. As reference Butisan S was applied without polymer. 14 days after treatment the rating was effected. The results are shown in the following table.

| | | post appl. |
|---|---|---|
| | | CHEAL |
| compound | g ai/ha | % control |
| Metazachlor (reference) | 187 | 45 |
| Without polymer | 47 | 0 |
| | 24 | 0 |
| metazachlor + polymer A | 187 + 187 | 50 |
| | 47 + 47 | 40 |
| | 24 + 24 | 15 |
| Metazachlor + polymer C | 187 + 187 | 25 |
| (comparative example) | 47 + 47 | 20 |
| | 24 + 24 | 0 |

As can be seen in the table, control of Chenopodium album, especially at low ai application rates, is increased with polymer A compared to the reference and to comparative polymer C.

1-16. (canceled)

17. A method for increasing the systemicity of a pesticide which comprises the step of applying the pesticide in combination with a copolymer obtainable by polymerization of
a) at least one compound of the formula (I) (monomer α)
wherein 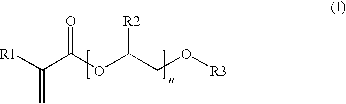
R1 and R2, independently of one another, are in each case H or CH₃,
R3 is C₆-C₁₀-aryl or C₇-C₁₂-aralkyl which can carry one or more identical or different C₁-C₉-alkyl and/or C₁-C₅-alkoxy substituents, and
n is an integer from 0 to 100,
b) at least one compound selected from the group consisting of N-vinylamides, N-vinyllactams, N-vinylimines and N-vinylamines with 2 to 15 carbon atoms (monomer β),
c) optionally one or more different difunctional crosslinker components,
d) optionally one or more different regulators, and
e) optionally one or more further copolymerizable components (monomer γ),
to a plant or its seed or other propagation material

18. The method as claimed in claim 17, wherein the copolymers are obtainable by polymerization of:
a) 1 to 30 mol % of at least one monomer of the formula (I), wherein
R1, R2 in each case independently of one another are H or CH₃,
R3 is phenyl which is unsubstituted or substituted with one or more identical or different substituents selected from C₁-C₉-alkyl and C₁-C₅-alkoxy,
n is an integer from 1 to 10,
b) 50 to 99 mol % of at least one monomer selected from the group consisting of monomers N-vinylpyrrolidone and N-vinylcaprolactam,
c) 0 to 3 mol % of one or more different difunctional crosslinker components,
d) 0 to 3 mol % of one or more different regulators and
e) 0 to 49 mol % of at least one monomer γ.

19. The method as claimed in claim 18, wherein the copolymers are obtainable by polymerization of:
1 to10 mol % of at least one monomer of the formula (I), where
R1, R2 in each case independently of one another are H or CH₃,
R3 is phenyl which is unsubstituted or substituted with one or more identical or different substituents selected from C₁-C₉-alkyl and C₁-C₅-alkoxy,
n is an integer from 1 to 2,
b) 90 to 99 mol % of N-vinylpyrrolidone,
c) 0 to 3 mol % of one or more different difunctional crosslinker components,
d) 0 to 3 mol % of one or more different regulators and
e) 0 to 49 mol % of at least one monomer γ.

20. The method as claimed in claim 17, wherein the pesticide is an insecticide or fungicide.

21. The method as claimed in claim 20, wherein the pesticide is an insecticide.

22. The method as claimed in claim 21, wherein the pesticide is a phenylpyrazole insecticide or a semicarbazone insecticide.

23. The method as claimed in claim 22, wherein the insecticide is selected from the group consisting of fipronil and metaflumizone.

24. The method as claimed in claim 17, wherein the weight ratio of pesticide to co-polymer is <6.

25. An agrochemical formulation comprising
A. 0.1 to 95% (by weight) of one or more copolymer wich is obtainable by polymerization of:
a) 1 to 30 mol % of at least one monomer of the formula (I), where
R1, R2 in each case independently of one another are H or CH₃,
R3 is phenyl which is unsubstituted or substituted with one or more identical or
different substituents selected from C₁-C₉-alkyl and C₁-C₅-alkoxy.
n is an integer from 1 to 10,
b) 50 to 99 mol % of N-vinylpyrrolidone,
c) 0 to 30 mol % of one or more different difunctional crosslinker components,
d) 0 to 3 mol % of one or more different regulators and
e) 0 to 49 mol % of at least one further monomer,
where the mol % data of the individual components must add up to 100 mol %,
B. 0.1 to 85% (by weight) of one or more pesticide selected from the group consisting of insecticides and fungicides, and
C. 0 to 70% by weight of one or more formulation auxiliaries,
wherein the weight ratio of B:A is <6.

26. The agrochemical formulation as claimed in claim 26, wherein the insecticide is selected from the group consisting of phenylpyrazole insecticides and semicarbazone insecticides.

27. The agrochemical formulation as claimed in claim 27, wherein the insecticide is selected from group consisting of fipronil and metaflumizone.

28. A method of combating harmful inscets and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the agrochemical formulation as claimed in claim 26.

29. A method of improving the health of plants, which comprises applying the formulation according to claim 26 to plants, parts of plants, or the locus where plants grow.

30. Seeds treated with the formulation of claim 26.
